(19) United States
(12) Patent Application Publication
(10) Pub. No.: US 2011/0226142 A1
(43) Pub. Date: Sep. 22, 2011

(54) SCREEN PRINTER, PRINTING FRAME, AND METHOD FOR PREPARATION OF A PRINTING FRAME

(75) Inventors: Hidetoshi MIMURA, Saitam (JP); Shigeki TANAKA, Kanagawa (JP); Yasuyuki MIKATSURA, Kanagawa (JP)

(73) Assignee: RISO KAGAKU CORPORATION, Tokyo (JP)

(21) Appl. No.: 13/047,071

(22) Filed: Mar. 14, 2011

(30) Foreign Application Priority Data
Mar. 19, 2010 (JP) 2010-088138

(51) Int. Cl. B05C 17/08

(52) U.S. Cl. 101/126; 101/129

(57) ABSTRACT

In a screen printer, printing frame for the screen printer and a preparation method therefor, the screen printer comprises a screen mesh, which is provided on a predetermined frame body so as to be stretched at a predetermined tensile strength, and a plate-making screen master, which is arranged on one of faces of the screen mesh, wherein the tensile strength at time of stretching the screen mesh is higher than that at time of arranging the screen master in the screen mesh.

### CROSS-REFERENCES TO RELATED APPLICATION

This application claims priority from Japanese Patent Application Serial No. 2010-088138 filed Mar. 19, 2010, the contents of which are incorporated herein by reference in its entirety.

### TECHNICAL FIELD

The present invention relates to a screen printer capable of manually or automatically performing screen printing, a printing frame therefor, and a method for preparation of the printing frame.

### BACKGROUND

Generally, a screen printer is used for various printing such as printing on cloth such as a T-shirt and a towel, a plastic member such as a nameplate, a signboard, etc., and glass such as a mirror and an ashtray.

For example, Japanese Patent Application Publication No. H10-95097 discloses a screen printer apparatus, in which a printing screen is stretched by four corners of a plate frame, and the screen is pressed by a squeegee and then moved so as to perform screen printing.

Moreover, Japanese Patent Application Publication No. 2003-291555 discloses an apparatus having a printing screen capable of maintaining, for a long time, a tension of a plate-making screen mesh by fixing four corners of the screen mesh with tension, to a support frame through a tension mesh.

The size of the printing screen is suitably designed depending on use thereof. Moreover, a non-printing area of an approximately 40 mm-80 mm width, that is, a portion (marginal area for fixing), which is fixed to a plate frame, and a portion (marginal area for printing), which is stretched when a squeegee is carried out, are required. In this case, there is a problem that the screen itself has to be enlarged in order to secure a larger printing area. However, such a large size screen has a problem, compared with a small size screen.

Specifically, although, in the screen printer of Japanese Patent Application Publication No. H10-95097, the screen is stretched with a constant tension with respect to a plate frame, a force larger than that used for the small size screen is required in order to give the same tension to the large size screen whose structure is the same as that of the small size screen, so that there is possibility that a stretch of a plate-making image on the screen and degradation of the screen due to application of an excessive tension thereto may arise.

Moreover, although the screen mesh is stretched through a tension mesh so as to reinforce strength thereof in the screen printer disclosed in Japanese Patent Application Publication No. 2003-291555, when a large size printing is performed, there is a possibility that the same problem as that of the screen printer disclosed in Japanese Patent Application Publication No. H10-95097 may arise.

### SUMMARY

The present invention is made in view of such a situation, and it is an object of the present invention to offer a screen printer capable of a large size screen printing with a simple structure.

In order to attain the above-mentioned purpose, a screen printer according to the present invention comprises a screen mesh (gauze), which is provided on a predetermined frame body so as to be stretched at a predetermined tensile strength, and a plate-making screen master, which is arranged on one of faces of the screen mesh, wherein the tensile strength at time of stretching the screen mesh is higher than that at time of arranging the screen master in the screen mesh.

Moreover, in the above-mentioned screen printer, at least part of the screen master may be fixed to one of the faces of the screen mesh.

Moreover, a screen printer comprises a screen mesh, which is provided so as to be stretched on a predetermined frame body at a predetermined tensile strength, a plate-making screen master, which is arranged on one of faces of the screen mesh, and a squeegee, which carries out squeegeeing of ink put on the other face of the screen mesh, wherein the tensile strength at time of stretching the screen mesh is higher than that at time of arranging the screen master in the screen mesh.

Moreover, a printing frame according to the present invention, comprises a screen mesh, which is provided so as to be stretched on a predetermined frame body at a predetermined tensile strength, and a plate-making screen master, which is arranged on one of faces of the screen mesh, wherein the tensile strength at time of stretching the screen mesh is higher than that at time of arranging the screen master in the screen mesh.

Moreover, in a method for preparation of a printing frame, having a screen mesh, which is provided so as to be stretched on a predetermined frame body at a predetermined tensile strength, and a plate-making screen master, which is arranged on one of faces of the screen meshes, wherein the tensile strength at time of stretching the screen mesh is higher than that at time of arranging the screen master in the screen mesh.

According to the present invention, since screen printing is realized by placing the screen master on the screen mesh, which is stretched on the frame body, an excessive tension is not given to the screen master, and an extension and degradation of a plate-making image can be also prevented even in case of large size printing such as printing of a A3 size sheet. Moreover, the material and size of the screen master are not limited because the screen mesh has a function of applying a tension, whereby various screen masters can be used therefor depending on situations. Moreover, it is not necessary to provide a printing marginal area to the screen master itself, so that only a small non-printing area is required.

Moreover, although it conventionally took about 10 minutes to perform screen master stretching work and tension adjustment work when only the plate-making screen master is stretched and used on a frame body, in the present invention, the screen master stretching work and tension adjustment work is not needed, so that only about two minutes is required to adjust the screen master.

Moreover, since squeegeeing is performed while the screen mesh and the screen master are overlaid so that they have thickness which is thicker than the that in the case where printing is performed by only a screen master, the ink pressure amount due to the squeegee increases, and it is possible to perform printing with thickness. Moreover, since more screen ink can be held therein, it is possible to prevent clogging resulting from dryness of the ink, so that it also becomes possible to print again after while.

### BRIEF DESCRIPTION OF THE DRAWINGS

Other features and advantages of the present screen printer, printing frame, and method for preparation of a printing frame will be apparent from the ensuing description, taken in conjunction with the accompanying drawings, in which:

FIG. 1 is a top plan view of a screen printer according to a first embodiment of the present invention;

FIG. 2 is a front elevational view of the screen printer according to the first embodiment of the present invention;

FIG. 3 is a partially enlarged cross sectional view thereof, taken along a line III-III of FIG. 1;

FIG. 4 is a drawing showing a variation of a sealing member of FIG. 3;

FIG. 5 is a partially enlarged cross sectional view thereof, taken along a line V-V of FIG. 1;

FIG. 6 is a partially enlarged cross sectional view thereof, taken along a line VI-VI of FIG. 1;

FIG. 7 is a top plan view of a screen printer according to a second embodiment of the present invention;

FIG. 8 is a front elevational view of the screen printer according to the second embodiment of the present invention; and

FIG. 9 is a partially enlarged view thereof, taken along a line IX-IX of FIG. 7.

### DESCRIPTION

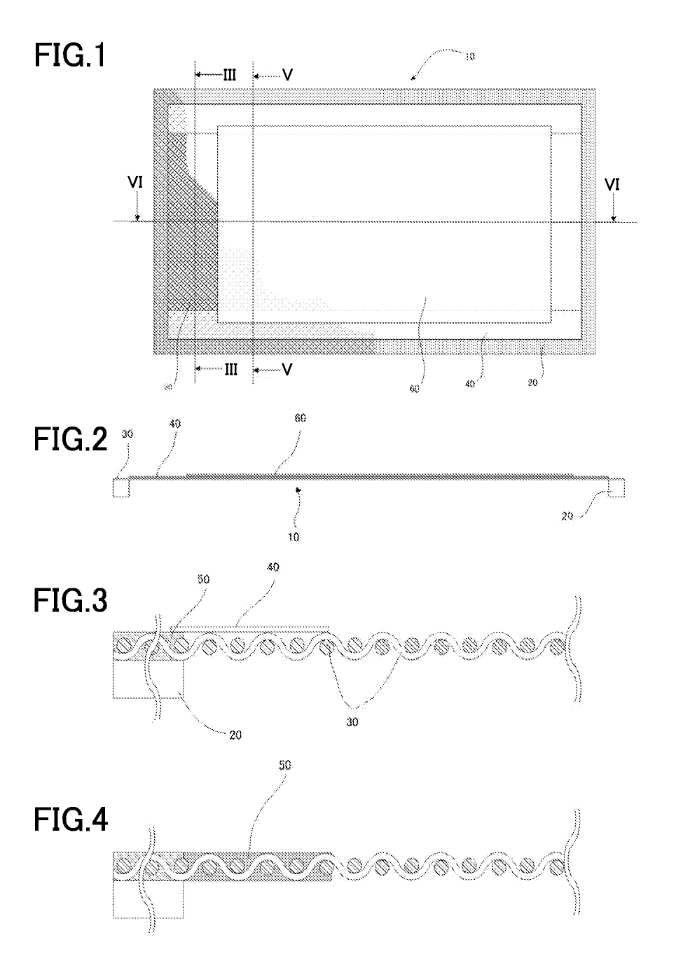

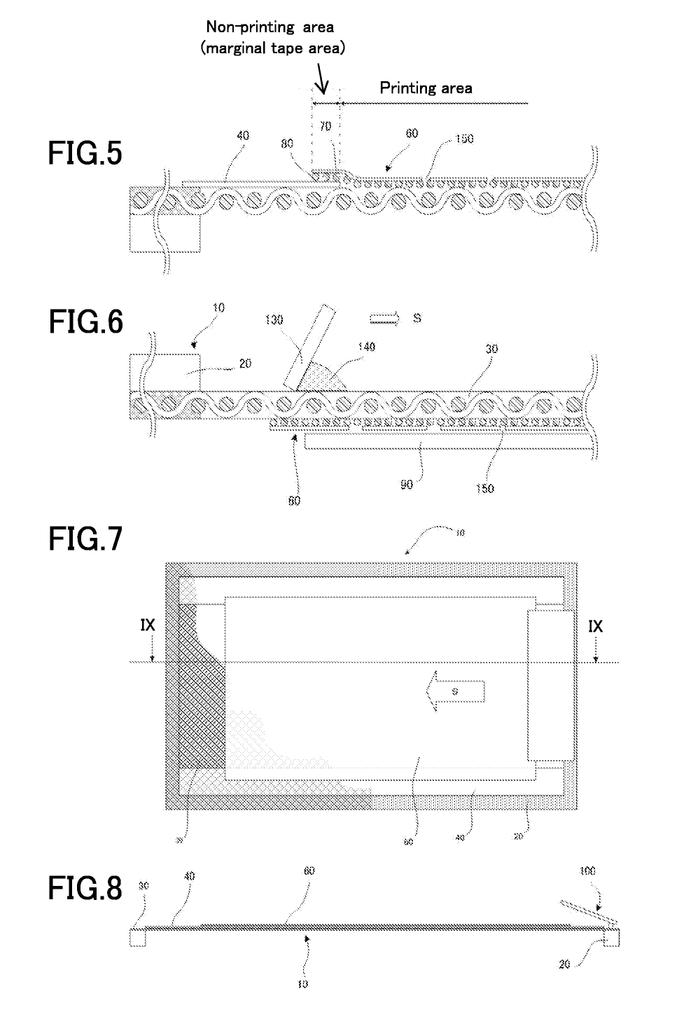

Description of a first embodiment of a screen printer 10 (printing frame 10) according to the present invention will be given below, referring to drawings. FIG. 1 is a top plan view of a screen printer 10 according to the first embodiment of the present invention. FIG. 2 is a front elevational view of the screen printer 10. FIG. 3 is a partially enlarged cross sectional view thereof, taken along a line III-III of FIG. 1. FIG. 4 is a drawing showing a variation of a sealing member of FIG. 3. FIG. 5 is a partially enlarged cross sectional view thereof, taken along a line V-V of FIG. 1. FIG. 6 is a partially enlarged cross sectional view thereof, taken along a line VI-VI of FIG. 1.

As shown in FIG. 1, a frame body 20, which is made of metal such as aluminum etc. and which is formed into a shape of frame, is provided in the screen printer 10 according to the present invention, wherein one face (back face) of a screen mesh 30 is bonded with an adhesive agent on the entire circumference of the frame body 20, so as to be stretched. A screen master 60, which has been formed as a printing plate, can be placed on the other face (front face) of this screen mesh 30. Moreover, as shown in FIG. 3, two sealing tapes 40 are firmly fixed to end sides on the front face of the screen mesh 30, which are parallel to each other in a longitudinal direction thereof.

For example, the frame body 20 is formed into a shape of a rectangle of 610 mm by 710 mm in outer circumference thereof, and has an opening of 550 mm by 650 mm therein, so that an A4 size screen master 60 (320 mm by 480 mm) can be fully used. Moreover, since the frame body 20 has only a function for stretching the screen mesh 30, as long as the strength thereof can be secured, any materials may be used therefor, in addition to aluminum.

As shown in FIG. 5, the screen master 60 is made by bonding together a thermoplastic film 70 and a support member 80, which has a mesh structure and which is made of polyethylene terephthalate. This screen master 60, in which a desired image is beforehand formed by a plate-maker such as SP400D manufactured by RISO KAGAKU CORPORATION, is used for printing. Film openings 150, which correspond to the image, are formed on an area of the screen master 60, which is a printing plate. In addition, the support member 80 may be made of polyethylene terephthalate and may also be made of porous material such as natural fiber, chemical fiber, synthetic fiber, or mixture thereof.

The screen mesh 30 is made from nylon wire rods, which are plain-woven in a shape of a net of approximately 50-100 meshes, and which are cut into a rectangle shape. Such a screen mesh 30 is provided so as to be stretched on the frame body 20 at a predetermined tensile strength.

Here, a tension intensity represents a tensile stress, which is generated when the screen mesh 30 is stretched on the frame body 20, or when the screen master 60 is stretched on the screen mesh 30. In addition, the higher the tensile stress generated when stretching, the higher the tension intensity. Moreover, the tension gauge is used as a method of adjusting the tension (tensile stress) of the actual screen mesh. The screen mesh 30 is stretched on the frame body 20, and the tension is adjusted by using a tension gauge “STG-75D” manufactured by TOYO CORPORATION, so that a value measured in a central part of the frame body 20 may fall within a range of 1.2-1.5 mm. This is a measured value showing a stretch at time of application of fixed tensile stress.

Moreover, the net (mesh) of the screen mesh 30 is arranged so as to have an angle of 45 degrees with respect to sides of the frame body 20 in a longitudinal direction thereof. Thus, by arranging it so as to have such an angle, an angle formed by a squeegee direction at time of performing a squeegee (direction, which is usually parallel to the sides of the frame body 20 in the longitudinal direction thereof) and the mesh of the screen mesh 30, is 45 degrees, so that it is possible to suppress shifting of the screen mesh 30 due to addition of the squeegee power. In addition, as long as the screen mesh 30 has the fixed tension intensity, material such as steel may be used. Moreover, any angle of the mesh of the screen mesh 30 and the frame body 20 may be suitably selected as long as the mesh of the screen mesh 30 and the frame body 20 are not parallel to each other or right-angled, so as to form an angle therebetween.

The sealing tapes 40 are attached to the other face of the screen mesh 30, which is not brought in contact with the frame body 20, along the longer sides of the frame body 20. The sealing tapes 40 respectively extend in a horizontal direction (left and right directions) on upper and lower sides of FIG. 1. An interval of these two sealing tapes 40 is designed so as to be slightly shorter than the length of the shorter sides of the A4 size screen master 60. That is, as shown in FIG. 5, since an end portion of the sealing tape 40 and that of the screen master 60 overlap each other, when squeegee of ink is performed, the ink does not leak from both side ends of the A4 size screen master 60. The length of the overlapping portion (marginal tape area) is enough if it is approximately 10 mm in width. In addition, since each of the sealing tapes 40 is made from a tape on which heat vapor deposition of aluminum foil is performed, water resistance thereof is excellent, so that it is possible to prevent degradation thereof due to ink. In addition, in FIG. 4, the screen mesh 30 is masked by resin 50, instead of using the sealing tapes 40. This structure is different from that of the sealing tapes 40, in that the screen master 60 can be placed uniformly on the surface of the screen mesh 30 without running on the sealing tapes 40 as shown in FIG. 5.

The squeegee 130 is a rectangular parallelepiped shape whose thickness is 10 mm, height is 50 mm and depth is 300 mm as shown in FIG. 6, and is made of resin whose squeegee hardness is 70 degrees. Since the depth of the screen master 60 is longer than the width thereof, when the squeegee 130 is once pressed thereon and moved to a squeegee direction S, it is possible to perform printing entirely.

Next, description of an operation in a print job by a user who uses the screen printer 10 according to the present embodiment, will be given below, referring to FIG. 6.

First, the user places the screen master 60 on the other face of the screen mesh 30, so that the support member 80 of the screen master 60 may be brought in contact with the screen mesh 30. The tension intensity of the screen master 60 at this time is set up lower than the tension intensity of the screen mesh 30, which has been stretched on the frame body. Specifically, the screen master 60 is overlaid on the screen mesh 30 only to the extent that the stretch of the screen master 60 may be reduced.

Next, the screen printer 10 is placed on a material 90 to be printed. At this time, a film 70 side of the screen master 60 faces the material 90 to be printed. In such a state where the screen printer 10 is placed on the material 90, screen ink 140 is put on one of the faces of the screen mesh 30. The screen ink 140 is placed on an upper stream side in a squeegee direction S. In this state, while the squeegee 130 is pressed down, it is moved in the squeegee direction S. The screen ink 140 passes through gaps of the screen mesh 30 and gaps of the mesh of the support member 80 by the pressing force of the squeegee 130, and then passes through the film openings 150 of the film 70, so as to be transferred onto the material 90 to be printed. Printing is completed by repeating this squeegee operation several times.

Thus, since the screen printer 10 of this embodiment has a dual structure which is made up of the screen mesh 30 and the support member 80 of the screen master 60, the amount of the screen ink 140 pressed by the squeegee 130 is large, so that the amount of ink transferred increases, whereby it is suitable for performing thick printing.

Here, an experimental result is shown in Table 1. In case of first through third examples, each of which has the dual structure, the amount of transferred ink greatly increased, compared with case where the experiment was conducted with a screen master of a comparative example 1. In addition, the kind of each mesh may be suitably selected depending on an intended purpose or a desirable image quality.

TABLE 1

| | | | | Evaluation |
|---|---|---|---|---|
| | | | Transferred | of the |
| | Screen | Screen | ink | transferred |
| | Master | Mesh | amount | ink amount |
| Comparative | 70 meshes | none | 15 g/m² | x |
| Example 1 | | | | |
| Example 1 | 70 meshes | 50 meshes | 22/m² | ∘ |
| Example 2 | 180 meshes | 135 meshes | 22/m² | ∘ |
| Example 3 | 180 meshes | 135 meshes | 21/m² | ∘ |

Moreover, the screen ink 140 remains in the screen printer 10, which has ended the printing. That is, in the screen printer 10 according to this embodiment, the screen ink 140 remains in the gaps of the screen master 60 having a mesh structure, and the gaps of the screen mesh 30. Since more screen ink 140 can be held because of the structure of these two meshes, it is possible to prevent clogging due to ink drying, so that it also becomes possible to print again after while. Specifically, when the screen mesh 30 is made of nylon (50 meshes), “RISO DIGITAL SCREEN MASTER 70P-32” manufactured by RISO KAGAKU CORPORATION (70 meshes) is used as the screen master 60, and “RISO SCREEN INK” manufactured by RISO KAGAKU CORPORATION is used as the ink, it is possible to prevent clogging for about 30 minutes due to humidity retention of the ink.

Moreover, if the screen master 60 is removed from the screen printer 10, which has ended printing, and the remaining ink 140 in the screen mesh 30 is washed, it can be used again.

Moreover, a moire phenomenon can be prevented by arranging the screen master 60 and the screen mesh 30, each of which has a mesh structure, so that these meshes may have a predetermined angle with each other.

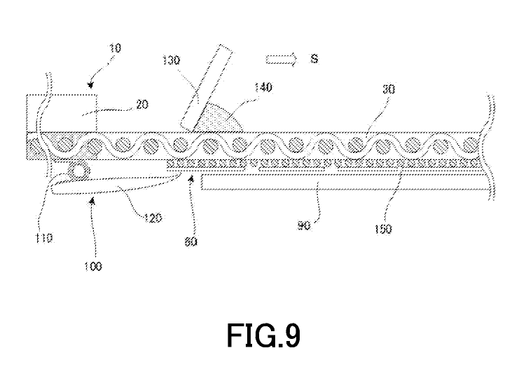

Next, description of a screen printer 10 according to a second embodiment of the present invention will be given below. FIG. 7 is a top plan view of the screen printer according to the second embodiment of the present invention. FIG. 8 is a front elevational view of the screen printer according to the second embodiment of the present invention. FIG. 9 is a partially enlarged view thereof, taken along a line IX-IX of FIG. 7.

The present embodiment is different from the first embodiment in that the screen printer 10 of the present embodiment has a screen master holding portion 100 for at least partially fixing the screen master to one of the faces of a screen mesh. The other structure of the present embodiment is the same as that of the first embodiment, and the same references numbers are assigned to the same elements as those of the first embodiment, and description thereof is omitted if needed.

As shown in FIG. 7, the screen master holding portion 100 is provided along a shorter side of a frame body 20, and holds the tip of the screen master 60. The screen master holding portion 100 has a holding member 120, which is brought in contact with the tip of the screen master 60, and a blade spring 110 for biasing the holding member 120 in a direction of holding the tip of the screen master 60.

Moreover, although, in this embodiment, the screen master holding portion 100 comprises the holding member 120 and the blade spring 110, the structure thereof is not limited thereto, and it is possible hold the portion of the screen master 60 with a commercial tape etc.

Next, an operation in a printing job by a user who uses the screen printer 10 according to the present embodiment, will be given below, referring to FIG. 9.

First, a user lays the screen master 60 on the other face of the screen mesh 30, so that the support member 80 of the screen master 60 may be brought in contact with the screen mesh 30. Next, the user fixes the position of the tip of the screen master 60 by the screen master holding portion 100. The tension intensity of the screen master 60 at this time is set up so as to be lower than the tension intensity of the screen mesh 30 stretched by the frame body 20. Specifically, the screen master 60 is desirably pressed down by the screen master holding portion 100 to the extent that the stretch may be reduced.

Next, the screen printer 10, which is holding the screen master 60, is placed on material 90 to be printed. At this time, a film 70 side of the screen master 60 faces the material 90 to be printed. In the state where the screen printer 10 is placed on the material 90 to be printed, screen ink 140 is put on one of the faces of the screen mesh 30. The screen ink 140 is placed on an upper stream side in a squeegee direction S and in a side where the screen master 60 is held by the screen master holding portion 100. In this state, while the squeegee 130 is pressed down, and it is moved in the squeegee direction S. The screen ink 140 passes through gaps of the screen mesh 30 and gaps of the mesh of the support member 80 by the pressing force of the squeegee 130, and then passes through the film openings 150 of the film 70, so that the ink is transferred onto the material 90 to be printed. Printing is completed by repeating this squeegee operation several times.

As explained above, according to the present invention, it becomes possible to perform large sized screen printing with a simple structure.

The preceding description has been presented only to illustrate and describe exemplary embodiments of the present screen printer, printing frame, and method for preparation of a printing frame. It is not intended to be exhaustive or to limit the invention to any precise form disclosed. It will be understood by those skilled in the art that various changes may be made and equivalents may be substituted for elements thereof without departing from the scope of the invention. In addition, many modifications may be made to adapt a particular situation or material to the teachings of the invention without departing from the essential scope. Therefore, it is intended that the invention not be limited to the particular embodiment disclosed as the best mode contemplated for carrying out this invention, but that the invention will include all embodiments falling within the scope of the claims. The invention may be practiced otherwise than is specifically explained and illustrated without departing from its spirit or scope.

What is claimed is:

1. A screen printer comprising:
a screen mesh (gauze), which is provided on a predetermined frame body so as to be stretched at a predetermined tensile strength; and
a plate-making screen master, which is arranged on one of faces of the screen mesh,
wherein the tensile strength at time of stretching the screen mesh is higher than that at time of arranging the screen master in the screen mesh.

2. The screen printer according to claim 1, wherein at least part of the screen master is fixed to the one of the faces of the screen mesh.

3. A screen printer, comprising:
a screen mesh, which is provided so as to be stretched in a predetermined frame body at a predetermined tensile strength;
a plate-making screen master, which is arranged on one of faces of the screen mesh; and
a squeegee, which carries out squeegeeing of ink put on the other face of the screen mesh,
wherein the tensile strength at time of stretching the screen mesh is higher than that at time of arranging the screen master in the screen mesh.

4. A printing frame comprising:
a screen mesh, which is provided so as to be stretched in a predetermined frame body at a predetermined tensile strength; and
a plate-making screen master, which is arranged on one of faces of the screen mesh,
wherein the tensile strength at time of stretching the screen mesh is higher than that at time of arranging the screen master in the screen mesh.

5. A method for preparation of a printing frame, having a screen mesh, which is provided so as to be stretched in a predetermined frame body at a predetermined tensile strength, and a plate-making screen master, which is arranged on one of faces of the screen meshes, wherein a tensile strength at time of stretching the screen mesh is higher than that at time of arranging the screen master in the screen mesh.
